(19) United States
(12) Patent Application Publication
(10) Pub. No.: US 2009/0129222 A1
(43) Pub. Date: May 21, 2009

(54) AN OPTICAL DRIVE WITH A VARYING BANDWIDTH

(75) Inventor: JOHANNES LEOPOLDUS BAKX, EINDHOVEN (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/994,546

(22) PCT Filed: Jun. 30, 2006
(86) PCT No.: PCT/IB2006/052196

§ 371 Date: Jan. 3, 2008

(30) Foreign Application Priority Data
Jul. 7, 2005 (EP) 05106170.3

(51) Int. Cl. G11B 27/22

(52) U.S. Cl. 369/47.36

(57) ABSTRACT

The invention discloses a method for operating an optical drive for e.g. a CD, DVD, HD-DVD or a BD disk. More specifically, the invention may improve the signal to noise ratio (SNR) and/or the carrier to noise ratio (CNR) during readout from an optical carrier by an optical drive by applying a low pass filter on a signal comprised in a data channel or an auxiliary channel of the optical drive. The low pass filter has a bandwidth frequency (f0) that is dependent on the tangential linear speed (v1) of the light beam (5) on the optical carrier. Thus, the present invention provides a dynamic way of setting the bandwidth of a low pass filter in the data channel, or an auxiliary channel. The present invention also relates to a corresponding optical drive.

The present invention relates to a method for operating an optical drive capable of reproducing/recording information from/to an optical carrier, e.g. a CD, DVD, HD-DVD or BD disk. More specifically, the invention may improve the signal to noise ratio (SNR) and/or the carrier to noise ratio (CNR) during readout from an optical carrier by an optical drive. The present invention also relates to a corresponding optical drive.

Optical storage of information on optical disk media, such as CD, DVD and BD, is being increasingly used in more and more applications. The information or the data is arranged in spiral-like tracks and written on and/or read from the optical disk media by a laser unit, the laser unit being positioned in a so-called optical pick-up unit (OPU) of an optical drive device. The OPU will also comprise photo detection means, such as a photo detector integrated circuit (PDIC), for detecting of the reflected laser light.

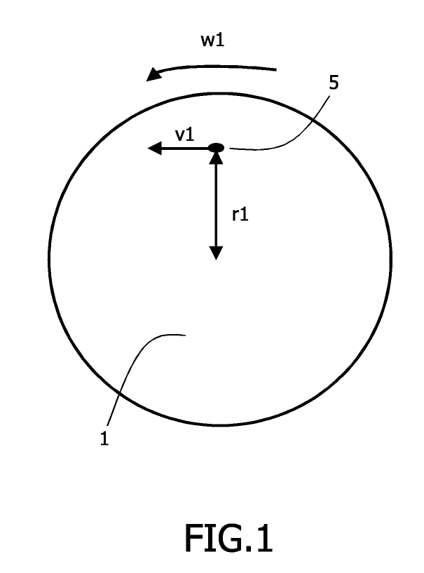

Retrieval of information from the disk media is performed by moving the OPU along the radial direction of the disk media during continuous rotation of the disk media with a certain angular frequency (w1). At a certain radial position (r1) of the disk media the laser beam (5) will have a corresponding tangential linear speed (v1) given by the product of the angular frequency (w1) and the radial position (r1); v1=r1×w1, see FIG. 1.

The spectrum of a data signal retrieved from a disk media will vary depending on the linear speed of the laser beam on the media. A data signal may define a path of data or a so-called channel through the data processing means of the optical drive when retrieving information from the media to an information receiver. In order to obtain a satisfactory readout signal, in particular a sufficiently high signal to noise ratio (SNR) at various points through the data processing it is common to apply one or more low pass filters to separate out high frequency noise components of the data. Low pass filters are characterized by their bandwidth i.e. cut-off frequencies e.g. −3 dB points such as it is commonly known in the art. The bandwidth chosen for low pass filtering is a compromise between having an acceptable signal to noise ratio (SNR) both at low and high tangential linear speed (v1) of the laser beam on the disk media. The bandwidth is usually set per disk type (CD, DVD, BD) and per speed (1×, 2×, 4×, 12× etc.). For CD the bandwidth is typically 1.5 MHz at a speed of 1×, for DVD the bandwidth is typically 9 MHz at a speed of 1× and for BD the bandwidth is typically 20 MHz at a speed of 1×.

Hitherto, it has not been a problem within the area of optical storage to obtain acceptable signal to noise ratios (SNR). In part, because the beam intensity of the laser beam has provided an easy way of increasing the signal to noise ratio (SNR), e.g. increasing the beam intensity immediately yields an improvement of the SNR of the readout signal.

However, with the present days applied laser beam intensity, such as for Blu-Ray Disc (BD), the laser power delivered to the disk media during reading and especially during recording is close to the level where damaging and/or detrimental effects to the written marks of write-once/write-many media is encountered.

Hence, an improved method for optical storage of information would be advantageous, and in particular a more efficient and/or reliable method capable of increasing the signal to noise ratio (SNR) would be advantageous.

Accordingly, the invention preferably seeks to mitigate, alleviate or eliminate one or more of the above mentioned disadvantages singly or in any combination. In particular, it may be seen as an object of the present invention to provide a method that solves the above mentioned problems of the prior art with insufficient signal to noise ratios (SNR).

This object and several other objects are obtained in a first aspect of the invention by providing a method for optimizing the signal to noise ratio (SNR) and/or the carrier to noise ratio (CNR) during readout from an optical carrier by an optical drive, said carrier comprising optically readable effects arranged in circles and/or spirals, the method comprising the steps of:

a) rotating the carrier by rotation means at an angular frequency (w1),
b) directing a focused light beam onto the carrier, the light beam having a tangential linear speed (v1) at a first radial position (r1) on the carrier,
c) detecting reflected light from the carrier by photo detection means, said photo detection means being adapted to generate first signals in response to said detected light,
d) generating from said first signals corresponding second signals by first processing means (ASP), said second signals being analog signals, and
e) generating from said second signals corresponding third signals by second processing means (DSP), said third signals being digital signals,

wherein the step d) and/or step e) comprises the sub-step of applying a low pass filter on any of said first, second, and third signals, said low pass filter having a bandwidth frequency (f0) being dependent on the tangential linear speed (v1) of the light beam on the optical carrier.

The invention is particularly, but not exclusively, advantageous for providing a method that avoids the bandwidth being fixed to a specific value during recording and/or reproduction of information to/from the optical carrier. Thus, given a value of the tangential linear speed (v1) of the radiation beam on the optical carrier, the bandwidth is chosen according to or in dependency of said value of the tangential linear speed (v1). The value of the tangential linear speed (v1) of the radiation beam on the optical carrier may also be a target value of the linear speed, as it will be explained in more detail below. Thus, the present invention provides a dynamic way of setting the bandwidth of a low pass filter in the data channel, or auxiliary channels, of an optical drive that may optimize readout performance from the optical carrier, in particular the signal to noise ratio (SNR) and/or the carrier to noise ratio (CNR) from the carrier.

Beneficially, the bandwidth frequency (f0) may be substantially proportional to the tangential linear speed (v1) of the radiation beam on the optical carrier. Thus, a simple scaling relationship may relate the bandwidth frequency (f0) and the linear speed.

For some embodiments the optical carrier may rotated at a substantially constant angular frequency (w1) for at least a pre-defined period of time during readout of the optical carrier. This is so-called constant angular velocity (CAV) condition applied for some optical drives. As a result a varying linear speed will be present at different radial positions of the carrier, and the present invention may be particular advantageous applied in order to change the bandwidth frequency as the radial position of the light beam is varied across the carrier.

For other embodiments the tangential linear speed (v1) of the focussed light beam on the carrier may be kept substantially constant for at least a pre-defined period of time during readout of the optical carrier. This is so-called constant linear velocity (CLV) condition applied for some optical drives. For such an optical drive it may be particularly useful to apply the present invention. This is especially the case when the drive is changing the radial position of the light beam. In that case, the bandwidth frequency may be adjusted to actual linear speed, and readout of the carrier can start immediately and it is therefore not necessary to wait until the rotational speed of the carrier has reached the relevant target speed. The access time by applying the present invention may accordingly be reduced with about 1 second.

Thus, the low pass filter may have a bandwidth frequency (f0) being dependent on the present value of the tangential linear speed (v1) of the light beam on the optical carrier.

Alternatively, the low pass filter may have a bandwidth frequency (f0) being dependent on a target value of the tangential linear speed (v1) of the light beam on the optical carrier in order to reduce access time for readout of the carrier.

Beneficially, the low pass filter may be applied in an analog domain of the first processing means (ASP). Some preferred filters include Butterworth filter and Bessel filters. The low pass filter may alternatively or additionally be applied in a digital domain of the second processing means (DSP). Filters may be of the finite impulse response (FIR) type.

The said low pass filter may also be applied on a wobble signal, where the wobble signal comprises information indicative of the wobbling of a track on the optical carrier. Alternatively or additionally, the wobble signal may be applied for measuring the tangential linear speed (v1) of the light beam on the optical carrier with relatively high precision. Alternatively, if for example it is impossible or difficult to obtain an indication of the linear tangential speed (v1) from a wobble signal it may be possible to obtain from the rotation means. If e.g. the rotation means comprises measuring means for measuring the actual angular frequency (w1) of the optical carrier. Thus, e.g. a tacho signal or a frequency signal from a closed loop control of the rotation means may be applied to obtain an indication of the linear tangential speed (v1) of the light beam on the carrier. This is typically a very stable option though not as precise an indication of the linear tangential speed (v1) obtainable from a wobble signal.

In a second aspect, the invention relates to an optical drive capable of optimizing the signal to noise ratio (SNR) and/or the carrier to noise ratio (CNR) during readout from an associated optical carrier, said carrier comprising optically readable effects arranged in circles and/or spirals, the optical drive comprises:

a) rotation means adapted for rotating the carrier at an angular frequency (w1),
b) means for directing a focused light beam onto the carrier, the light beam having a tangential linear speed (v1) at a first radial position (r1) on the carrier,
c) photo detection means capable of detecting reflected light from the carrier, said photo detection means being adapted to generate first signals in response to said detected light,
d) first processing means (ASP) capable of generating from said first signals corresponding second signals, said second signals being analog signals, and
e) second processing means (DSP) capable of generating from said second signals corresponding third signals, said third signals being digital signals,

wherein the optical drive is further adapted to apply a low pass filter on any of said first, second, and third signals, said low pass filter having a bandwidth frequency (f0) being dependent on the tangential linear speed (v1) of the light beam on the optical carrier.

In a third aspect, the invention relates to a computer program product being adapted to enable a computer system comprising at least one computer having data storage means associated therewith to control an optical drive according to the third aspect of the invention.

This aspect of the invention is particularly, but not exclusively, advantageous in that the present invention may be implemented by a computer program product enabling a computer system to perform the operations of the second aspect of the invention. Thus, it is contemplated that some known optical drive may be changed to operate according to the present invention by installing a computer program product on a computer system controlling the said optical drive. Such a computer program product may be provided on any kind of computer readable medium, e.g. magnetically or optically based medium, or through a computer based network, e.g. the Internet.

The first, second and third aspect of the present invention may each be combined with any of the other aspects. These and other aspects of the invention will be apparent from and elucidated with reference to the embodiments described hereinafter.

The present invention will now be explained, by way of example only, with reference to the accompanying Figures, where

FIG. 1 is a schematic illustration of an optical carrier being rotated and a focused light beam located on the carrier,

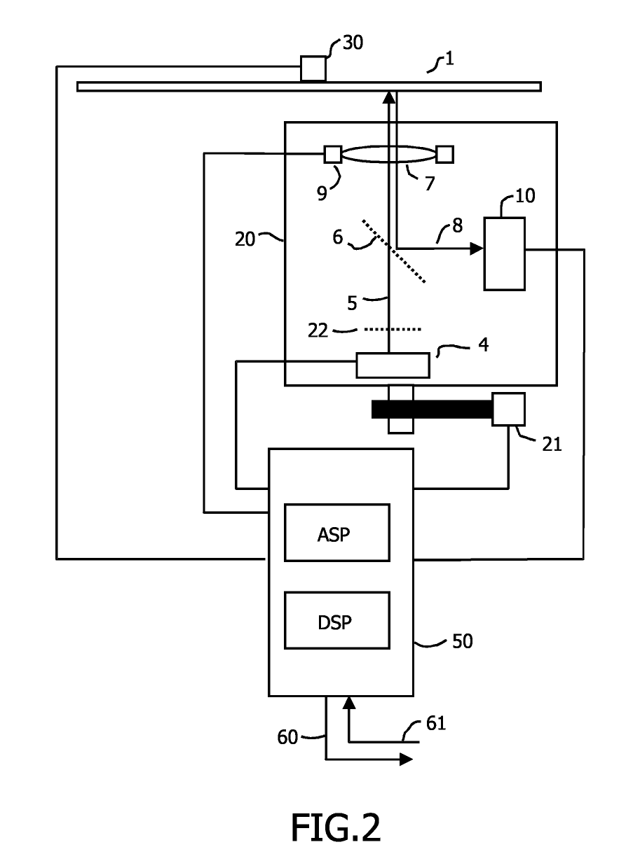

FIG. 2 is a schematic block diagram of an embodiment of an optical drive according to the present invention,

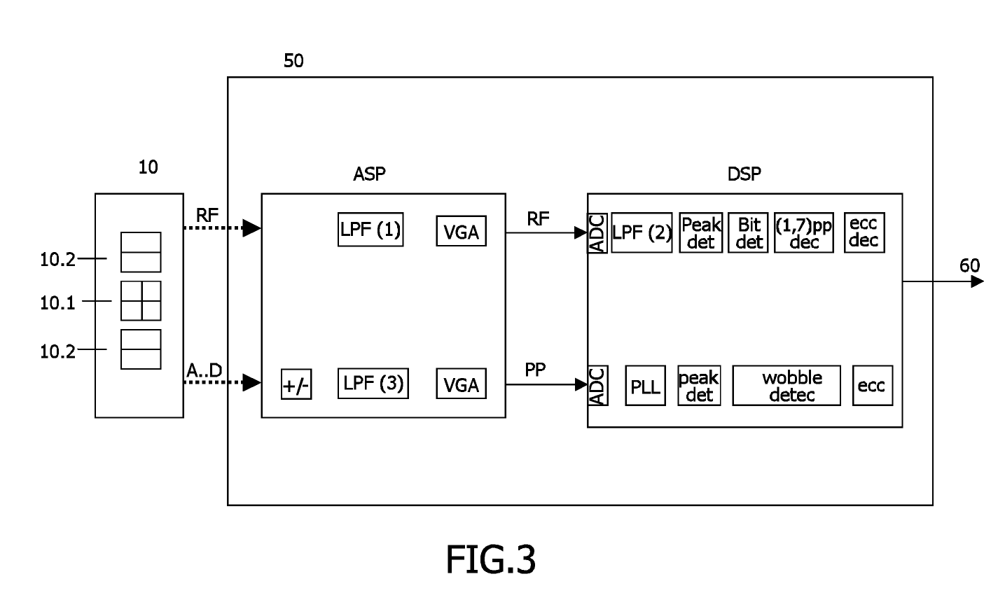

FIG. 3 is schematic block diagram of a processor of an optical drive according to the present invention,

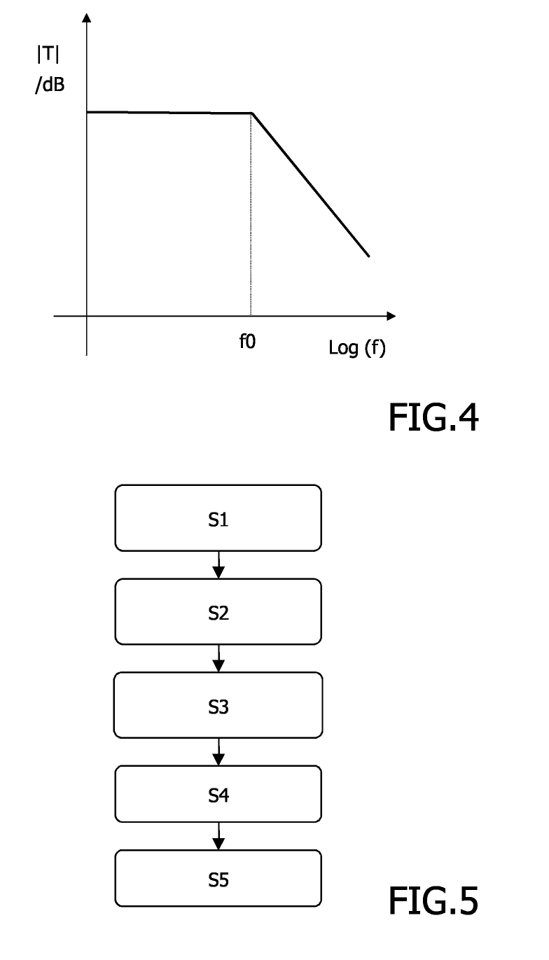

FIG. 4 is a Bode-plot showing the numerical transfer function as a function of logarithmic frequency, and

FIG. 5 is a flow-chart of a method according to the invention.

FIG. 1 is a schematic illustration of a optical carrier 1 being rotated at an angular frequency w1 and a focused light beam 5 located on the carrier 1. The beam 4 is positioned at a radial distance r1 from the centre of the carrier 1. At that radial position the focused beam 5 has a tangential linear speed v1. The tangential linear speed v1 is given by the product of the angular frequency w1 and the radial distance r1; v1=r1×w1.

FIG. 2 shows an optical apparatus or drive and an optical information carrier 1 according to the invention. The carrier 1 is fixed and rotated by holding means 30.

The carrier 1 comprises a material suitable for recording information by means of a radiation beam 5. The recording material may be of, for example, the magneto-optical type, the phase-change type, the dye type, metal alloys like Cu/Si or any other suitable material. Information may be recorded in the form of optically detectable regions, also called marks for rewriteable media and pits for write-once media, on the carrier 1.

The apparatus comprises an optical head 20, sometimes called an optical pick-up (OPU), the optical head 20 being displaceable by actuation means 21, e.g. an electric stepping motor. The optical head 20 comprises a photo detection system 10, a radiation source 4, a beam splitter 6, an objective lens 7, and lens displacement means 9 capable of displacing the lens 7 both in a radial direction of the carrier 1 and in the focus direction. The optical head 20 may also comprises beam splitting means 22, such as a grating or a holographic pattern that is capable of splitting the radiation beam 5 into at least three components for use in the three spot differential push-pull radial tracking, or any other applicable control method. For clarity reason, the radiation beam 5 is shown as a single beam after passing through the beam splitting means 22. Similarly, the radiation 8 reflected may also comprise more than one component, e.g. the three spots and diffractions thereof, but only one beam 8 is shown in FIG. 1 for clarity.

The function of the photo detection system 10 is to convert radiation 8 reflected from the carrier 1 into electrical signals. Thus, the photo detection system 10 comprises several photo detectors, e.g. photodiodes, charged-coupled devices (CCD), etc., capable of generating one or more electric output signals that may be defined as first signals with the context of the present invention. The photo detectors are arranged spatially to one another, and with a sufficient time resolution so as to enable detection of error signals i.e. focus FE and radial tracking RE. The focus FE and radial tracking error RE signals are transmitted to the processor 50 where commonly known servomechanism operated by usage of PID control means (proportional-integrate-differentiate) is applied for controlling the radial position and focus position of the radiation beam 5 on the carrier 1.

The photo detection system 10 can also output a read signal or RF signal representing the information being read from the carrier 1 to the processor 50. The read signal may possibly be converted to a central aperture (CA) signal by a low-pass filtering of the RF signal in the processor 50.

The radiation source 4 for emitting a radiation beam or a light beam 5 can for example be a semiconductor laser with a variable power, possibly also with variable wavelength of radiation. Alternatively, the radiation source 4 may comprise more than one laser. In the context of the present invention, the term “light” is consider to comprise any kind of electromagnetic radiation suitable for optical recording and/or reproduction, such as visible light, ultraviolet light (UV), infrared light (IR) etc.

The optical head 20 is optically arranged so that the radiation beam 5 is directed to the optical carrier 1 via a beam splitter 6, and an objective lens 7. Radiation 8 reflected from the carrier 1 is collected by the objective lens 7 and, after passing through the beam splitter 6, falls on a photo detection system 10 which converts the incident radiation 8 to electric output signals as described above.

The processor 50 receives and analyses first signals from the photo detection means 10. The processor 50 can also output control signals to the actuation means 21, the radiation source 4, the lens displacement means 9, and the rotating means 30, as schematically illustrated in FIG. 2. Similarly, the processor 50 can receive data, indicated at 61, and the processor 50 may output data from the reading process as indicated at 60. As shown in FIG. 2, the processor 50 comprises two parts; a first processing means being an analog signal processor ASP (also called a RF processor) and second processing means being a digital signal processor DSP.

FIG. 3 is schematic block diagram of the processor 50 of an optical apparatus shown in FIG. 2. Additionally, the photo detection means 10 is shown to the left of the processor 50 with schematically drawing of the one central photo detector 10.1 divided into four sections for the central beam 8 and two neighboring photo detectors 10.2, each divided into two sections, for satellite beams of the central beam 8.

From the photo detection means 10 a first signal, termed RF in FIG. 3, is transmitted to the processor 50. Processing of this first signal trough the processor 50 defines a RF channel or a RF data path as indicated in the upper part of the processor 50. Normally, the first RF signal is the sum of light intensities incident on the central detector 10.1.

From the photo detection means 10 another first signal, termed A . . . D in FIG. 3, is also transmitted to the processor 50. The A . . . D signals comprises separate components of the different photo detector sections of the photo detectors 10.1 and 10.2 for subsequent use in focus error tracking, radial error tracking, wobble signal, synchronizing with write clock obtaining mirror signals etc. Processing of this first signal trough the processor 50 defines an auxiliary channel or an auxiliary data path as indicated in the lower part of the processor 50.

In the processor 50, three blocks with low pass filters, LPF(1), LPF(2), and LPF(3) in the upper and lower channel are indicated as possible embodiments of the present invention.

The three embodiments are separate and independent embodiments, and thus, any combination of the three embodiments is possible. Moreover, the skilled person may realize other possible application of low pass filters according to the present invention, preferably within the processor 50. In one example though, the low pass filtering may be performed in the optical head 20 but because the head 20 has only a limited space available and should have a low weight cost this is not preferred. Additionally, for the lower, auxiliary channel a low pass filter LPF(4) may be applied in the DSP just after the ADC.

In the upper channel, the first RF signal is initially low pass filtered through LPF(1) and then amplified in the variable gain amplifier VGA. The signal before or after amplification may be considered a second signal according to the present invention.

The RF second signal is transmitted to the DSP for initial analog to digital conversion in the ADC Thus, after conversion to the digital domain the RF signal may be considered a third signal according to present invention. Subsequently, in the digital domain, the low pass filter LPF(2) is to be applied on the third signals in dependency of the tangential linear speed v1. This is very easy to implement at this stage in the upper channel as the high frequency components in the frequency domain are simply excluded. After peak determination in the block Peak det, which may be applied for a controlling the variable gain amplifier VGA, bit detection is performed in the block termed Bit det by a commonly used process in the field e.g. threshold detection or Viterbi detection. After bit detection, a channel decoder e.g. (1,7) pp dec is applied. (1,7) pp dec is the channel code used e.g. in BD drives. Finally, error correction code (ECC) decoding is performed according to an appropriate standard. Thus, for CD the standard is CIRC, for DVD the standard is the RS product code, and for BD the standard is LDC+BIS.

In the lower channel, first signals A . . . D are transmitted to a sum difference circuit +/− for processing of the relevant first signals A . . . D for radial tracking, e.g. a push pull signal PP, and filtered through the lower pass filter LPF(3) according to the present invention. It is a particular advantage to apply the filter at this stage of the lower channel because after the undesirable high frequency components are take out, the common problem of aliasing with analog to digital conversion may be avoided or limited. Before or after filtering in LPF(3) the lower channel may be considered to comprise second signals according to the present invention. After amplification at the lower VGA, the second signals PP are transmitted to the DSP.

The PP second signal is transmitted to the DSP for initial analog to digital conversion in the lower ADC of the DSP, this ADC being a flash ADC outputting a PCM signal. Thus, after conversion to the digital domain the PP signal may be considered a third signal according to present invention. In the DSP, the third signal is applied for phase-lock-loop PLL for synchronizing with e.g. a writing clock for timing of writing on the carrier 1. Similarly, peak determination in the block Peak det may be applied for a controlling the variable gain amplifier VGA of the lower channel in the ASP. The DSP also determines the wobble frequency, wobble amplitude etc. by wobble detection means. In a particular embodiment of the invention, the wobble detection means may be applied for determining the tangential linear speed v1 of the light beam 5 on the carrier 1 with relatively high precision. Because the tolerance on the wobble period in length is very small, the precision can be better than, e.g. 2%. Additionally, there an ecc block in the lower channel because during and after recording there may be crosstalk from the RF-channel to the lower wobble channel, which decreases the wobble SNR significantly.

FIG. 4 is a Bode-plot showing the numerical transfer function |T| as a function of logarithmic frequency of a low pass filter. In general, a low pass filter attenuates high frequencies, but leaves low frequencies relatively unaffected. A low pass filter may be characterized by a bandwidth f0, e.g. the frequency where the relative amplitude has decreased 3 dB. Additionally, the filters are named according to the rate of attenuation above the bandwidth f0, thus a 1^{st} order filter attenuates 20 dB per decade of frequency, a 2^{nd} order filter attenuates 40 dB per decade of frequency, and so fourth. Many kinds of filters are possible both in the digital domain and the analog domain (both active and passive implementations). Thus, it is within the teaching of the present invention to apply any kind of low pass filter available to the skilled person. In general, a steep low pass filter i.e. a high order is preferred in order to suppress noise outside of the signal band, but the filter should also not significantly affect the timing of the zero transitions in the data signal.

For the upper channel, preferred filters in the ASP is low pass filters LPF(1) being Butterworth filters of 3^{rd} order of the programmable type. For the DSP the low pass filter LPF(2) is of the FIR-type. For the lower channel in the ASP, the low pass filter LPF(3) may be any convenient type that is programmable. Additional type of filters may e.g. be found in Microelectronic Circuits by A. S. Sedra and K. C. Smith, Saunders College Publishing, 1991.

Mathematically, the principle of the present invention i.e. the low pass filter LPF having a bandwidth frequency f0 being dependent on the tangential linear speed v1 of the radiation beam 5 on the optical carrier may be expressed as;

f0=f0(v1).

In an embodiment, the functional relationship is given as a simple proportionality;

f0=k1×v1,

where k1 is pre-determined constant. However, the functional relationship is not limited to any specific mathematical relationship. Thus, if for example the functional relationship could be a linear relation

f0=k1×v1+k2,

k2 being a pre-determined constant, a quadratic relation, a square-like relation, a polynomial relation, an exponential relation etc. It is contemplated that for practical applications appropriate fitting functions may be applied, said functions having the property that for high linear speeds the filtering becomes more dominant than at low linear speeds, which may be required to maintain an acceptable SNR.

FIG. 5 is a flow-chart of a method according to the invention. The method is capable of optimizing the signal to noise ratio (SNR) and/or the carrier to noise ratio (CNR) during readout from the optical carrier 1. The method comprises the steps of:

S1, rotating the carrier 1 by rotation means 30 at an angular frequency w1,

S2, directing a focused light beam 5 onto the carrier, the light beam or radiation beam 5 having a tangential linear speed v1 at a first radial position 1 on the carrier as seen in FIG. 1,

S3, detecting reflected light 8 from the carrier by photo detection means 10, said photo detection means being adapted to generate first signals in response to said detected light as seen in FIG. 2,

S4, generating from said first signals corresponding second signals by first processing means ASP, said second signals being analog signals, and

S5 generating from said second signals corresponding third signals by second processing means DSP, said third signals being digital signals,

wherein the step S4 and/or step S5 comprises the sub-step of applying a low pass filter LPF 1, LPF 2 or LPF 3 on any of said first, second, and third signals. The low pass filter has a bandwidth frequency or cut-off frequency f0 being dependent on the tangential linear speed v1 of the light beam 5 on the optical carrier.

Although the present invention has been described in connection with the specified embodiments, it is not intended to be limited to the specific form set forth herein. Rather, the scope of the present invention is limited only by the accompanying claims. In the claims, the term comprising does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. A method for optimizing the signal to noise ratio (SNR) and/or the carrier to noise ratio (CNR) during readout from an optical carrier (1) by an optical drive, said carrier comprising optically readable effects arranged in circles and/or spirals, the method comprising the steps of:
a) rotating the carrier (1) by rotation means (30) at an angular frequency (w1),
b) directing a focused light beam (5) onto the carrier, the light beam (5) having a tangential linear speed (v1) at a first radial position (r1) on the carrier,
c) detecting reflected light (8) from the carrier by photo detection means (10), said photo detection means being adapted to generate first signals in response to said detected light,
d) generating from said first signals corresponding second signals by first processing means (ASP), said second signals being analog signals, and
e) generating from said second signals corresponding third signals by second processing means (DSP), said third signals being digital signals,
wherein the step d) and/or step e) comprises the sub-step of applying a low pass filter (LPF 1, LPF 2, LPF 3) on any of said first, second, and third signals, said low pass filter having a bandwidth frequency (f0) being dependent on the tangential linear speed (v1) of the light beam (5) on the optical carrier.

2. A method according to claim 1, wherein the bandwidth frequency (f0) is substantially proportional to the tangential linear speed (v1) of the radiation beam on the optical carrier (1).

3. A method according to claim 1, wherein the optical carrier (1) is rotated at a substantially constant angular frequency (w1) for at least a pre-defined period of time during readout of the optical carrier.

4. A method according to claim 1, wherein the tangential linear speed (v1) of the focussed radiation beam (5) on the carrier (1) is kept substantially constant for at least a pre-defined period of time during readout of the optical carrier.

5. A method according to claim 1, wherein the said low pass filter has a bandwidth frequency (f0) being dependent on a target value of the tangential linear speed (v1) of the light beam (5) on the optical carrier.

6. A method according to claim 1, wherein the said low pass filter has a bandwidth frequency (f0) being dependent on the present value of the tangential linear speed (v1) of the light beam (5) on the optical carrier.

7. A method according to claim 1, wherein the low pass filter is applied in an analog domain of the first processing means (ASP).

8. A method according to claim 1, wherein the low pass filter is applied in a digital domain of the second processing means (DSP).

9. A method according to claim 1, wherein the said low pass filter is applied on a wobble signal, said wobble signal comprising information indicative of the wobbling of a track on the optical carrier.

10. A method according to claim 9, wherein the wobble signal is applied for measuring of the tangential linear speed (v1) of the light beam (5) on the optical carrier.

11. A method according to claim 1, wherein the rotation means (30) comprises measuring means for measuring the actual angular frequency (w1) of the optical carrier.

12. An optical drive capable of optimizing the signal to noise ratio (SNR) and/or the carrier to noise ratio (CNR) during readout from an associated optical carrier (1), said carrier comprising optically readable effects arranged in circles and/or spirals, the optical drive comprises:
a) rotation means (30) adapted for rotating the carrier (1) at an angular frequency (w1),
b) means (4, 7) for directing a focused light beam (5) onto the carrier, the light beam (5) having a tangential linear speed (v1) at a first radial position (r1) on the carrier,
c) photo detection means (10) capable of detecting reflected light (8) from the carrier, said photo detection means being adapted to generate first signals in response to said detected light,
d) first processing means (ASP) capable of generating from said first signals corresponding second signals, said second signals being analog signals, and
e) second processing means (DSP) capable of generating from said second signals corresponding third signals, said third signals being digital signals,
wherein the optical drive is further adapted to apply a low pass filter (LPF 1, LPF 2, LPF 3) on any of said first, second, and third signals, said low pass filter having a bandwidth frequency (f0) being dependent on the tangential linear speed (v1) of the light beam (5) on the optical carrier.

13. A computer program product being adapted to enable a computer system comprising at least one computer having data storage means associated therewith to control an optical drive according to claim 1.
